(19) United States
(12) Patent Application Publication
(10) Pub. No.: US 2026/0302669 A1
(43) Pub. Date: Oct. 1, 2026

(54) CABLE-END CONNECTOR, BOARD-END CONNECTOR, AND CONNECTOR ASSEMBLY

(71) Applicant: ADVANCED-CONNECTEK INC., New Taipei City (TW)

(72) Inventors: Shu-Fen WANG, New Taipei City (TW); Kuan-Lin Chen, New Taipei City (TW)

(21) Appl. No.: 19/634,639

(22) Filed: Mar. 31, 2026

(30) Foreign Application Priority Data
Apr. 1, 2025 (TW) 114203294

(51) Int. Cl. H01R 12/79; H01R 12/77

(52) U.S. Cl. CPC H01R 12/79; H01R 12/774

(57) ABSTRACT

A connector assembly includes a cable-end connector and a board-end connector adapted to be mated with each other. The cable-end connector includes a mating shell, a circuit board, and a plurality of locking members. One of two ends of the circuit board includes a mating end portion exposed from the mating shell. The locking members are at buckling portions at two sides of the mating shell. The board-end connector includes a mating housing, a first terminal module and a second terminal module which are in the mating shell, and a covering housing covering the mating shell. Each of two sides of the mating housing has an engaging portion. When the cable-end connector and the board-end connector are mated with each other, the locking members at two sides of the cable-end connector are engaged with the engaging portions at two sides of the board-end connector.

### CROSS-REFERENCE TO RELATED APPLICATION

This non-provisional application claims priority under 35 U.S.C. § 119 (a) to patent application No. 114203294 filed in Taiwan, R.O.C. on Apr. 1, 2025, the entire contents of which are hereby incorporated by reference.

### FIELD OF THE INVENTION

The instant disclosure relates to a connector, and more particular to a cable-end connector, a board-end connector, and a connector assembly.

### BACKGROUND

The connection interfaces in telecommunication industry are developed to be lightweight and tiny and to have stable signal transmissions. For the connection interfaces applied in high-speed transmission server and switch, for example, the mini cool edge IO (MCIO) connector, the MCIO connector has a small size plus reliable and stable connection.

An MCIO connector known to the inventor includes a board-end connector and a cable-end connector. The cable-end connector comprises a cable, a PCB, and a plug on the PCB. The plug has a plastic core, upper and lower terminals, a hook member, and a pulling belt connected to the hook member. After the board-end connector and the cable-end connector are mated with each other, by pulling the pulling belt outward to drive the hook member above the plastic core to be released, the hook member can be detached from the buckle of the board-end connector, so that the cable-end connector can be detached from the board-end connector. However, the complexity and the number of components of the cable-end connector increase, and thus the manufacturing cost for the connector is high.

### SUMMARY OF THE INVENTION

In view of these, one embodiment of the instant disclosure provides a cable-end connector comprising a mating shell, a circuit board, and a plurality of locking members. The mating shell has a receiving cavity. Two ends of the mating shell respectively have a mating opening and a cable-connecting opening which are in communication with the receiving cavity. Each of two sides of the mating shell has a buckling portion. The circuit board is in the receiving cavity. One of two ends of the circuit board comprises a mating end portion exposed from the mating opening, and two faces of the mating end portion have a plurality of first contacts. Each of the locking members comprises a main body and a flexible sheet, the main body of each of the locking members is at a corresponding one of the buckling portions, the flexible sheet extends outward from the main body, and two sides of the flexible sheet respectively comprise a press portion and a hook portion.

In some embodiments, each of the buckling portions comprises two side wall portions and an insertion block, the side wall portions protrude from the two sides of the mating shell, and the insertion block extends outward from the side wall portions and adjacent to two sides of the mating opening. An outer wall of each of the side wall portions has an inclined surface, each of the buckling portions has a first buckling groove and a second buckling groove, the first buckling groove is between the side wall portions, and the second buckling groove is at a side end of the insertion block. The press portion is exposed from the first buckling groove and is movably adjacent to the inclined surface, and the hook portion is movably exposed from the second buckling groove.

In some embodiments, the cable-end connector further comprises a covering member, the mating shell has a recessed portion at the cable-connecting opening, and the covering member is at the recessed portion to cover the cable-connecting opening.

In some embodiments, the other end of the circuit board comprises a connecting end portion, and two faces of the connecting end portion have a plurality of second contacts.

In some embodiments, the cable-end connector further comprises an optoelectronic conversion module on the circuit board.

Another embodiment of the instant disclosure provides a board-end connector. The board-end connector is arranged on a circuit board and adapted to be mated with a cable-end connector. The board-end connector comprises a mating housing, a first terminal module, a second terminal module, and a covering housing. The mating housing has a receiving groove. Two ends of the board-end connector respectively have an insertion opening and an assembling opening which are in communication with the receiving groove. Each of two sides of the mating housing has an engaging portion, the engaging portions are adapted to be mated with buckling portions of the cable-end connector, and the insertion opening is adapted to be mated with a mating end portion of a circuit board of the cable-end connector. The first terminal module comprises a first terminal base and a plurality of first flexible terminals at the first terminal base. Each of the first flexible terminals comprises a first contact portion, and each of the first contact portions is at one of two sides of the receiving groove and extends toward the insertion opening. The second terminal module comprises a second terminal base and a plurality of second flexible terminals at the second terminal base. Each of the second flexible terminals comprises a second contact portion, and each of the second contact portions is at the other side of the receiving groove and extends toward the insertion opening. The covering housing covers the mating shell.

In some embodiments, each of the engaging portions has a slide groove. The slide grooves are recessed inward from the two sides of the mating housing, the slide grooves are at two sides of the insertion opening, and each of the engaging portions has an engaging groove at an inner wall of a corresponding one of the slide grooves.

In some embodiments, the board-end connector further comprises a grounding sheet between the first terminal module and the second terminal module. Each of two sides of the grounding sheet comprises a pin exposed from the assembling opening.

In some embodiments, the circuit board has a plurality of contacts and a plurality of fixing holes. Each of the first flexible terminals comprises a first tail portion, and each of the second flexible terminals comprises a second tail portion. Each of the first tail portions and each of the second tail portions are exposed from the assembling opening and connected to corresponding ones of the contacts, each of two sides of the covering housing comprises a fixing leg, and each of the fixing legs is at a corresponding one of the fixing holes.

In some embodiments, the board-end connector further comprises an optoelectronic conversion module on the circuit board.

Yet another embodiment of the instant disclosure provides a connector assembly comprising a cable-end connector and a board-end connector. The cable-end connector comprises a mating shell, a circuit board, and a plurality of locking members. The mating shell has a receiving cavity. Two ends of the mating shell respectively have a mating opening and a cable-connecting opening which are in communication with the receiving cavity. Each of two sides of the mating shell has a buckling portion. The circuit board is in the receiving cavity. One of two ends of the circuit board comprises a mating end portion exposed from the mating opening, and two faces of the mating end portion have a plurality of first contacts. Each of the locking members comprises a main body and flexible sheet, the main body of each of the locking members is at a corresponding one of the buckling portions, the flexible sheet extends outward from the main body, and two sides of the flexible sheet respectively comprise a press portion and hook portion. The board-end connector comprises a mating housing, a first terminal module, a second terminal module, and a covering housing. The mating housing has a receiving groove. Two ends of the board-end connector respectively have an insertion opening and an assembling opening which are in communication with the receiving groove. Each of two sides of the mating housing has an engaging portion, the engaging portions are adapted to be mated with the buckling portions of the cable-end connector, and the insertion opening is adapted to be mated with the mating end portion of the circuit board of the cable-end connector. The first terminal module comprises a first terminal base and a plurality of first flexible terminals at the first terminal base. Each of the first flexible terminals comprises a first contact portion, each of the first contact portions is at one of two sides of the receiving groove and extends toward the insertion opening, and each of the first contact portions is adapted to contact a corresponding one of the first contacts at one of the two faces of the mating end portion. The second terminal module comprises a second terminal base and a plurality of second flexible terminals at the second terminal base. Each of the second flexible terminals comprises a second contact portion, each of the second contact portions is at the other side of the receiving groove and extends toward the insertion opening, and each of the second contact portions is adapted to contact a corresponding one of the first contacts at the other face of the mating end portion. The covering housing covers the mating housing.

According to some embodiments of the instant disclosure, when the cable-end connector and the board-end connector are mated with each other, the locking members at two sides of the cable-end connector are engaged with the engaging portions at two sides of the board-end connector. Therefore, the cable-end connector can be properly inserted into the board-end connector and cannot be detached easily, so that the release-proof function for the connector assembly can be achieved.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a connector assembly according to some embodiments of the instant disclosure;

FIG. 2 illustrates a front exploded view of a cable-end connector according to some embodiments of the instant disclosure;

FIG. 3 illustrates a rear exploded view of the cable-end connector according to some embodiments of the instant disclosure;

FIG. 4 illustrates a front exploded view of a board-end connector according to some embodiments of the instant disclosure;

FIG. 5 illustrates a rear exploded view of the board-end connector according to some embodiments of the instant disclosure;

FIG. 6 illustrates a cross-sectional view of the connector assembly according to some embodiments, where the board-end connector and the cable-end connector are not mated with each other yet;

FIG. 7 illustrates a cross-sectional view of the connector assembly according to some embodiments, where the board-end connector and the cable-end connector are mated with each other;

FIG. 8 illustrates a top sectional view of the connector assembly according to some embodiments, where the board-end connector and the cable-end connector are not mated with each other yet;

FIG. 9 illustrates a top sectional view of the connector assembly according to some embodiments, where the board-end connector and the cable-end connector are mated with each other; and

FIG. 10 illustrates a cross-sectional view of the connector assembly according to some embodiments, where each of the board-end connector and the cable-end connector has an optoelectronic conversion modules.

### DETAILED DESCRIPTION

To illustrate the embodiments of the instant disclosure more clearly, in the drawings, the first axis X is the X axis of the Cartesian coordinate, the second axis Y is the Y axis of the Cartesian coordinate, and the third axis Z is the Z axis of the Cartesian coordinate.

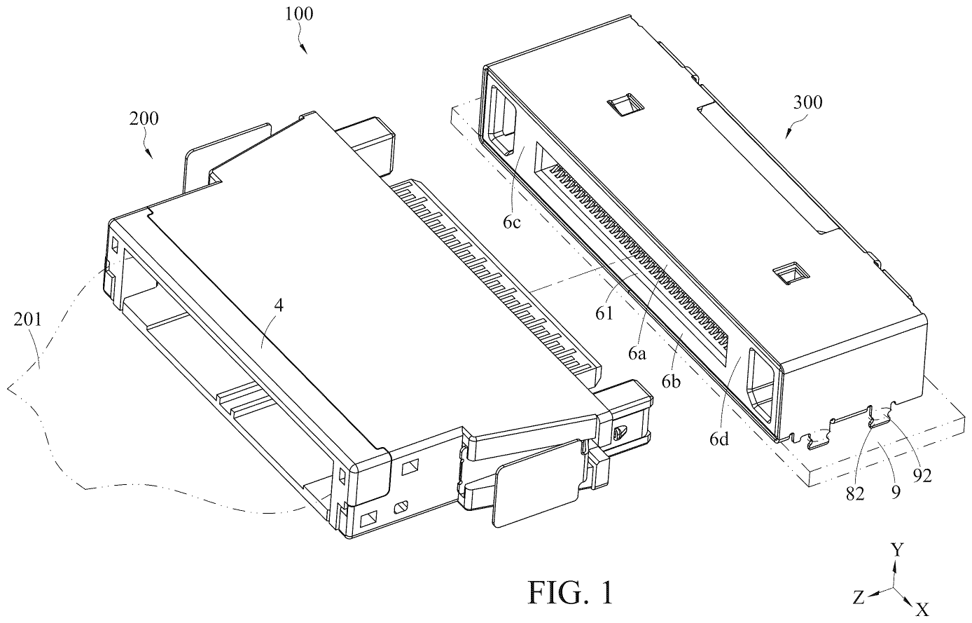

Please refer to FIG. 1. FIG. 1 illustrates a perspective view of a connector assembly 100. The signal transmitted by the connector assembly 100 is identical to the signal transmitted by an MCIO connector, and the connector assembly 100 is utilized for peripheral component interconnect express (PCIe) standard; while the structure of the connector assembly 100 is different from the structure of the MCIO connector. In this embodiment, the connector assembly 100 comprises a cable-end connector 200 and a board-end connector 300.

The cable-end connector 200 is adapted to be connected to a transmission cable 201 which transmits optical-fiber signals. The long side of the cable-end connector 200 extends along the first axis (X direction), the short side of the cable-end connector 200 extends along the third axis (Z direction), and the height of the cable-end connector 200 extends along the second axis (Y direction).

The board-end connector 300 is an elongated connector, and the board-end connector 300 is assembled on a circuit board 9. The long side of the board-end connector 300 extends along the first axis (X direction), the short side of the board-end connector 300 extends along the third axis (Z direction), and the height of the board-end connector 300 extends along the second axis (Y direction). The height of the board-end connector 300 is greater than the height of the cable-end connector 200.

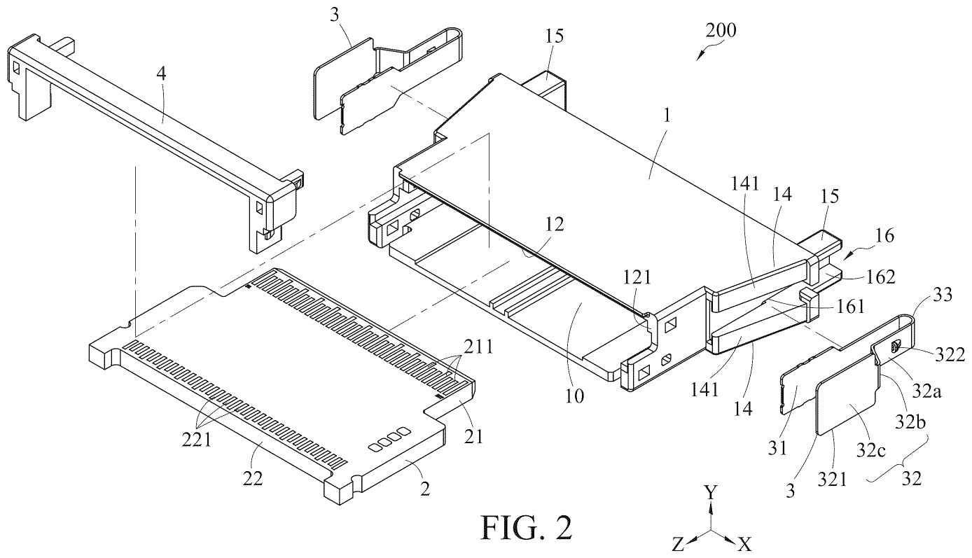

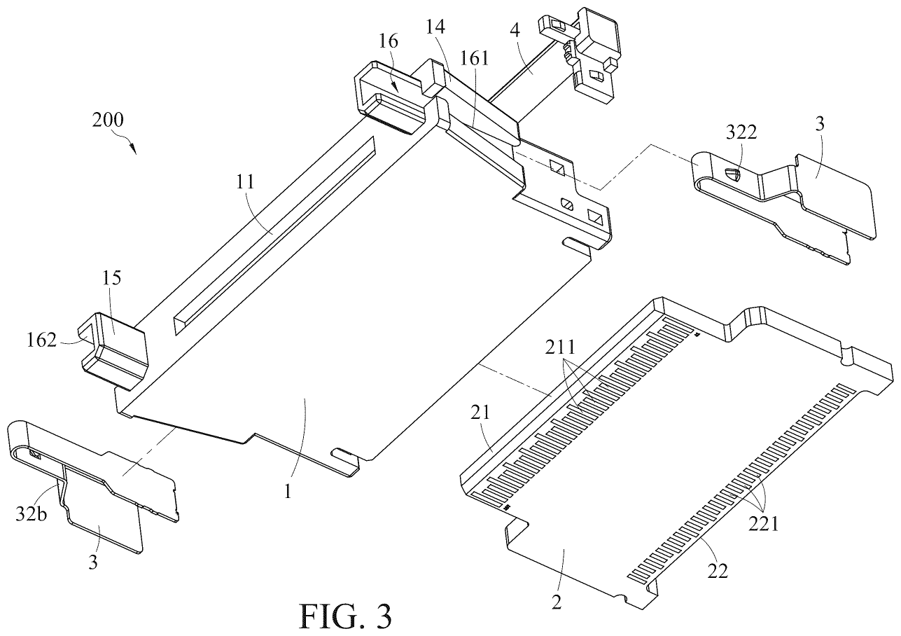

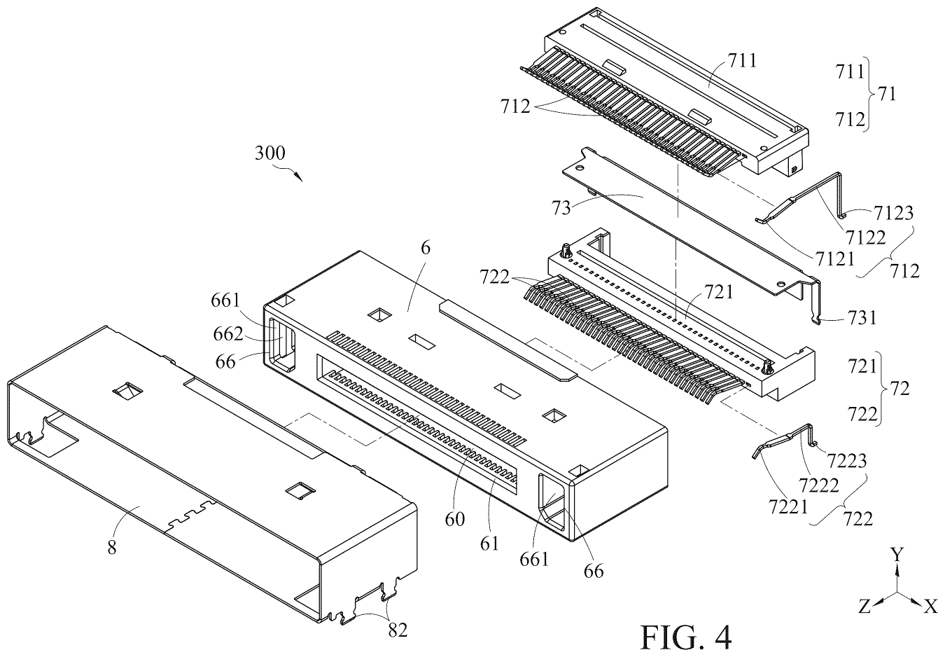

Please refer to FIG. 2 to FIG. 4. FIG. 2 illustrates a front exploded view of the cable-end connector 200. FIG. 3 illustrates a rear exploded view of the cable-end connector 200. FIG. 4 illustrates a front exploded view of the board-end connector 300. In this embodiment, the cable-end connector 200 is a plug and comprises a mating shell 1, a circuit board 2, and a plurality of locking members 3. The mating shell 1 is a hollow elongated shell. The mating shell 1 has a receiving cavity 10, two ends of the mating shell 1 respectively have a mating opening 11 and a cable-connecting opening 12 which are in communication with the receiving cavity 10. An opening area of the mating opening 11 is less than an opening area of the cable-connecting opening 12. Each of two sides of the mating shell 1 has a buckling portion 16. In some embodiments, each of the buckling portions 16 comprises two side wall portions 14 and an insertion block 15. The side wall portions 16 protrude from the two sides of the mating shell 1, the insertion block 15 extends outward from the side wall portions 14 along the third axis (Z direction) and adjacent to two sides of the mating opening 11. An outer wall of each of the side wall portions 14 has an inclined surface 141. Each of the buckling portions 16 has a first buckling groove 161 and a second buckling groove 162, the first buckling groove 161 is between the side wall portions 14, and the second buckling groove 162 is at a side end of the insertion block 15.

The circuit board 2 is in the receiving cavity 10. One of two ends of the circuit board 2 comprises a mating end portion 21 exposed from the mating opening 11. Two faces of the mating end portion 21 have a plurality of first contacts 211. The other end of the circuit board 2 comprises a connecting end portion 22. Two faces of the connecting end portion 22 have a plurality of second contacts 221. A width of the mating end portion 21 along the first axis (X direction) is less than a width of the connecting end portion 22 along the first axis (X direction).

Each of the locking members 3 comprises a main body 31 and a flexible sheet 32. The main body 31 of each of the locking members 3 is at a corresponding one of the buckling portions 16, and the flexible sheet 32 extends outward from the main body 31. The flexible sheet 32 has a turning portion 33, one end of the main body 31 and one end of the flexible sheet 32 are connected to each other through the turning portion 33, and the main body 31 and the flexible sheet 32 are arranged side-by-side and parallel to each other. Viewing from the second axis (Y direction), the main body 31 and the flexible sheet 32 are formed as a U-shaped structure. Two sides of the flexible sheet 32 respectively comprise a press portion 321 and a hook portion 322. When each of the locking members 3 is assembled with a corresponding one of the buckling portions 15, as shown in FIG. 1, the press portion 321 is exposed from the first buckling groove 161, and the hook portion 322 is exposed from the second buckling groove 162.

Please refer to FIG. 2 to FIG. 4. In some embodiments, the flexible sheet 32 has a first section 32a, a second section 32b, and a third section 32c. The first section 32a and the third section 32c are thin sheet arranged along the third axis (Z direction), the first section 32a and the third section 32c are arranged on different horizontal lines, and the second section 32b is an inclined sheet between the first section 32a and the third section 32c. One end of the main body 31 extends toward the first section 32a of the flexible sheet 32 through the turning portion 33, and the first section 32a sequentially extends toward the second section 32b and the third section 32c. The first section 32a is adjacent to the main body 31, and the third section 32c is away from the main body 31. The press portion 321 is at the third section 32c, and the hook portion 322 is at the first section 32a. In this embodiment, the hook portion 322 is a protruding block outward extending from a side surface of the first section 32a along the first axis (X direction).

Please refer to FIG. 2 to FIG. 4. In some embodiments, the cable-end connector 200 further comprises a covering member 4. Viewing from the third axis (Z direction), the covering member 4 is formed as a reverse U-shaped structure, and the covering member 4 is formed using low-pressure injection molding techniques. The mating shell 1 has a recessed portion 121 at the connecting opening 12, and the covering member 4 is at the recessed portion 121. When the circuit board 2 in the cable-end connector 200 is connected to the transmission cable 201, the portion of the transmission cable 201 within the connecting opening 12 is covered by the covering member 4 (as shown in FIG. 1), so that the portion of the transmission cable 201 within the connecting opening 201 is enclosed.

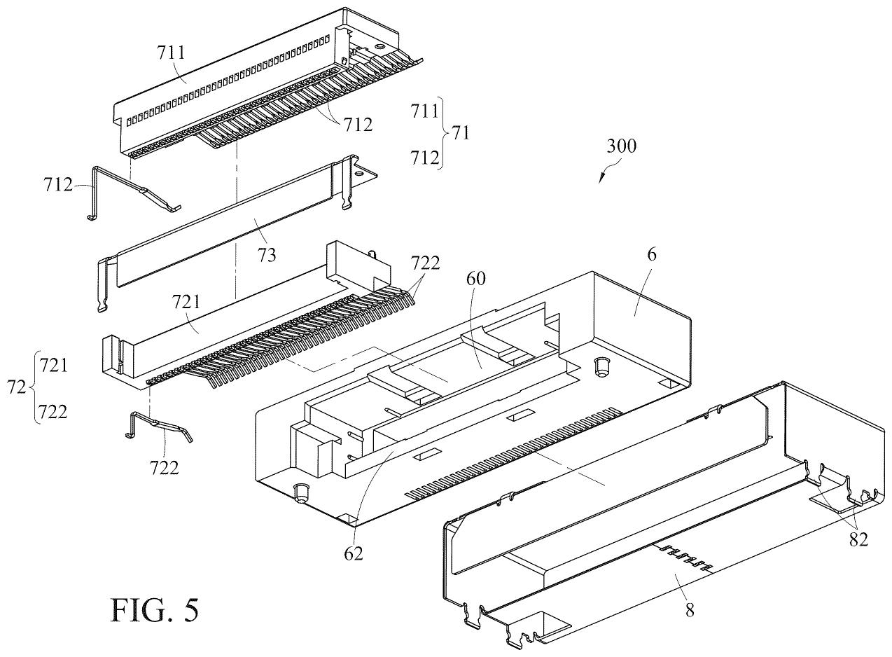

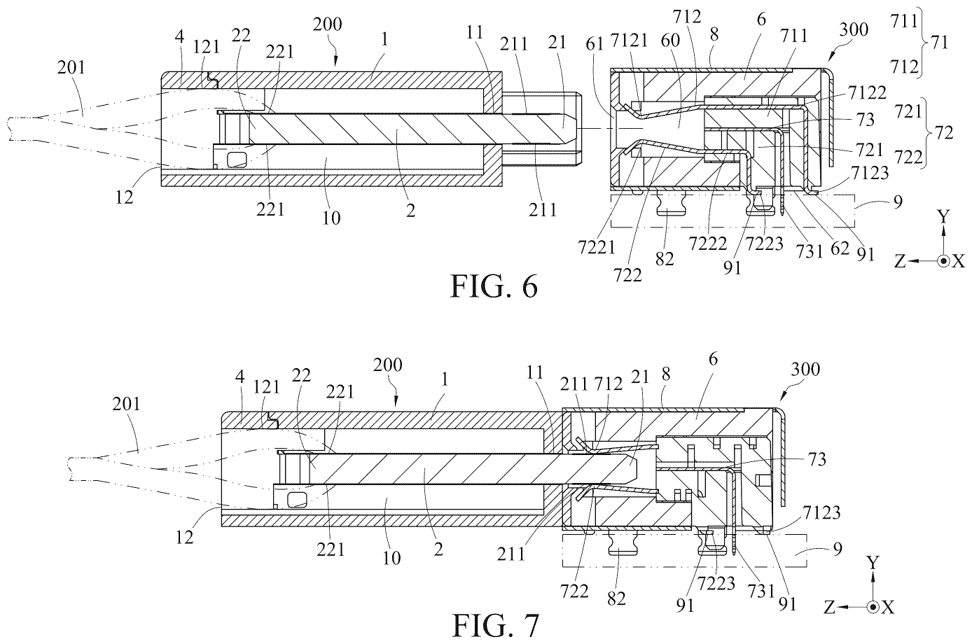

Please refer to FIG. 4 to FIG. 6. FIG. 5 illustrates a rear exploded view of the board-end connector 300. FIG. 6 illustrates a cross-sectional view of the connector assembly 100, where the board-end connector 300 and the cable-end connector 200 are not mated with each other yet. The board-end connector 300 comprises a mating housing 6, a first terminal module 71, a second terminal module 72, and a covering housing 8. The mating housing 6 is a hollow elongated housing and has a receiving groove 60. Two ends of the mating housing 6 respectively have an insertion opening 61 and an assembling opening 62 which are in communication with the receiving groove 60. The mating housing 6 comprises a first wall 6a and a second wall 6b which are arranged side-by-side along the first axis (X direction) and the mating housing 6 comprises a third wall 6c and a fourth wall 6d which are arranged side-by-side along the second axis (Y direction), as shown in FIG. 1. Two sides of the first wall 6a and two sides of the second wall 6b are respectively connected to the third wall 6c and the fourth wall 6d. The insertion opening 61 is enclosed by the first wall 6a, the second wall 6b, the third wall 6c, and the fourth wall 6d which are together formed as a complete rectangular structure. Each of two sides of the mating housing 6 has an engaging portion 66. In some embodiments, each of the engaging portions 66 has a slide groove 661, and the slide grooves 661 are recessed inward from the two sides of the mating housing 6 along the third axis (Z direction). The side grooves 661 are at two sides of the insertion opening 61, and each of the engaging portions 66 has an engaging groove 662 at an inner wall of a corresponding one of the slide grooves 661.

The first terminal module 71 comprises a first terminal base 711 and a plurality of first flexible terminals 712 at the first terminal base 711. The number of the first flexible terminals 712 is thirty-seven and the first flexible terminals 712 are adapted for signal transmission. In FIG. 4, for illustrative purpose, one of the first flexible terminals 712 is detached from the first terminal base 711. The first terminal base 711 is formed with the first flexible terminals 712 through injection molding techniques. As shown in FIG. 6, viewing from the first axis (X direction), each of the first flexible terminals 712 is formed as a mirrored L-shaped structure. Each of the first flexible terminals 712 comprises a first contact portion 7121, a first body portion 7122, and a first tail portion 7123. The first body portion 7122 is between the first contact portion 7121 and the first tail portion 7123, the first body portion 7122 is combined with the first terminal base 711, and the first contact portion 7121 is at one of two sides of the receiving groove 60 and extends toward the insertion opening 61. As shown in FIG. 6, the first contact portion 7121 is arranged at an upper position of the receiving groove 60 along the second axis (Y direction), and the first tail portion 7123 is exposed from the assembling opening 62 of the mating shell 6.

The second terminal module 72 comprises a second terminal base 721 and a plurality of second flexible terminals 722 at the second terminal base 721. The second terminal base 721 is combined with the first terminal base 711. The number of the second flexible terminals 722 is thirty-seven and the second flexible terminals 722 are adapted for signal transmission. In FIG. 4, for illustrative purpose, one of the second flexible terminals 722 is detached from the second terminal base 712. The second terminal base 712 is formed with the second flexible terminals 722 through injection molding techniques. As shown in FIG. 6, viewing from the first axis (X direction), each of the second flexible terminals 722 is formed as a mirrored L-shaped structure. Each of the second flexible terminals 722 comprises a second contact portion 7221, a second body portion 7222, and a second tail portion 7223. The second body portion 7222 is between the second contact portion 7221 and the second tail portion 7223, the second body portion 7222 is combined with the second terminal base 712, and the second contact portion 7221 is at the other side of the receiving groove 60 and extends toward the insertion opening 61. As shown in FIG. 6, the second contact portion 7221 is arranged at a lower position of the receiving groove 60 along the second axis (Y direction), and the second tail portion 7223 is exposed from the assembling opening 62 of the mating shell 6.

Please refer to FIG. 4 to FIG. 6. In some embodiments, the board-end connector 300 further comprises a grounding sheet 73. The grounding sheet 73 is a plate arranged horizontally and along the first axis (X direction). The grounding sheet 73 is between the first terminal module 71 and the second terminal module 72. Each of two sides of the grounding sheet 73 comprises a pin 731 exposed from the assembling opening 62, and the pins 731 are adapted to be connected to the circuit board 9.

Please refer to FIG. 1 and FIG. 4 to FIG. 6. In some embodiments, the circuit board 9 has a plurality of contacts 91 and a plurality of fixing holes 92. The first tail portion 7123 of each of the first flexible terminals 712 and the second tail portion 7223 of each of the second flexible terminals 722 are exposed from the assembling opening 62. Each of two sides of the covering housing 8 comprises a fixing leg 82. When the board-end connector 300 is assembled on the circuit board 9, each of the first tail portions 7123 and each of the second tail portions 7223 are connected to corresponding ones of the contacts 91 of the circuit board 9, and the fixing legs 82 at the two sides of the covering housing 8 are connected to the fixing holes 92.

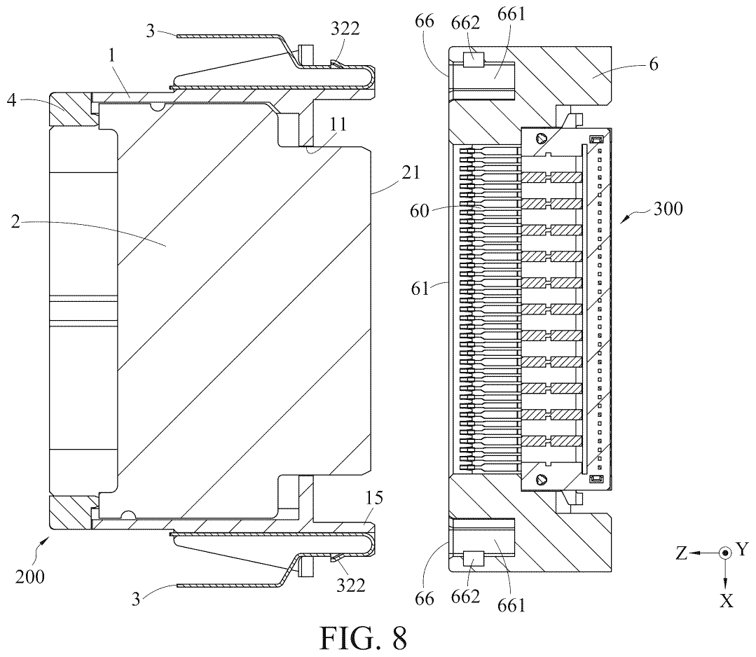

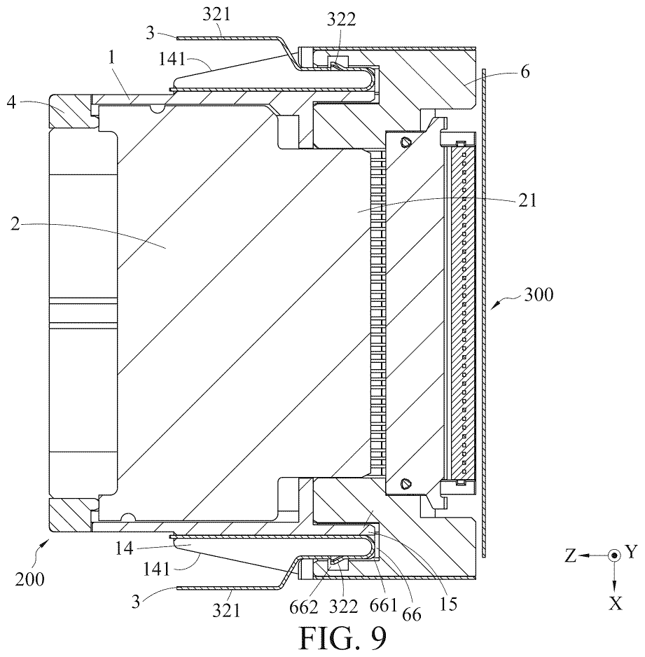

Please refer to FIG. 6 to FIG. 9. FIG. 7 illustrates a cross-sectional view of the connector assembly 100, where the board-end connector 300 and the cable-end connector 200 are mated with each other. FIG. 8 illustrates a top sectional view of the connector assembly 100, where the board-end connector 300 and the cable-end connector 200 are not mated with each other yet. FIG. 9 illustrates a top sectional view of the connector assembly 100, where the board-end connector 300 and the cable-end connector 200 are mated with each other. When the cable-end connector 200 of the connector assembly 100 is mating with the board-end connector 300 of the connector assembly 100, the cable-end connector 200 is aimed at and inserted into the board-end connector 300 along the third axis (Z direction), so that the two buckling portions 16 of the mating shell 1 and the mating end portion 21 of the circuit board 2 are respectively inserted into the two engaging portions 66 and the insertion opening 61 of the mating shell 6, and the first flexible terminals 712 of the first terminal module 71 and the second flexible terminals 722 of the second terminal module 72 respectively contact the first contacts 211 at the two faces of the circuit board 2. Next, the hook portions 322 of the locking members 3 are engaged with the engaging portions 66. In other words, in some embodiments, the insertion block 15 of the buckling portion 16 is inserted into the slide groove 661 of the engaging portion 66, so that the hook portions 322 (protrusions) of the locking members 3 are engaged with the engaging grooves 662 of the slide grooves 661. Therefore, the cable-end connector 200 can be properly and stably mated with the board-end connector 300.

Moreover, when the cable-end connector 200 is to be detached from the board-end connector 300, as shown in FIG. 9, the press portions 321 of the locking members 3 can be pressed along the first axis (X direction), so that the press portions 321 swing relative to each other to move toward the inclined surfaces 141 of the side wall portions 14 (or to contact the inclined surface 141 to provide an operation feeling indicating that the locking members 3 are positioned). The movement of the press portions 321 also drives the hook portions 322 to move and thus detach from the engaging grooves 662. Next, after the locking members 3 are disengaged from the buckling portions 16 of the mating shell 1, the cable-end connector 200 can be pulled from the board-end connector 300 along a direction away from the board-end connector 300, so that the cable-end connector 200 and the board-end connector 300 can be detached from each other.

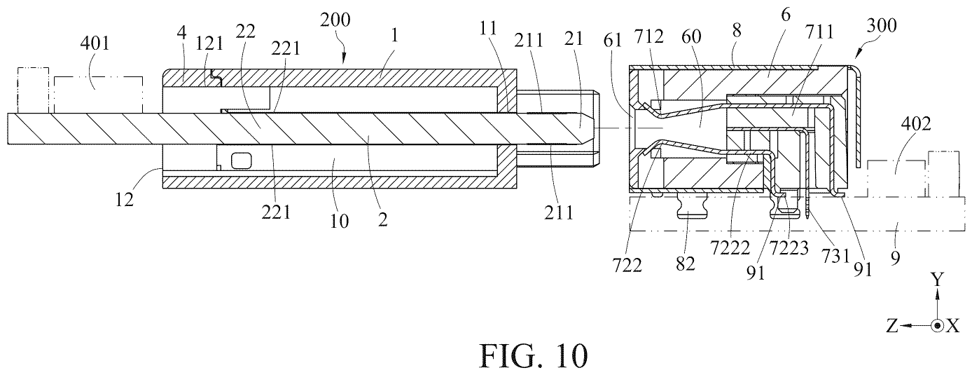

Please refer to FIG. 10. FIG. 10 illustrates a cross-sectional view of the connector assembly 100. In some embodiments, the cable-end connector 200 further comprises an optoelectronic conversion module 401 on the circuit board 2. Through the optoelectronic conversion module 401, the cable-end connector 200 can transmit not only power signals but also optical-fiber signals. Moreover, in some embodiments, the board-end connector 300 further comprises another optoelectronic conversion module 402 on the circuit board 9. Through the optoelectronic conversion module 402, the board-end connector 300 can transmit not only power signals but also optical-fiber signals.

According to some embodiments of the instant disclosure, when the cable-end connector and the board-end connector are mated with each other, the locking members at two sides of the cable-end connector are engaged with the engaging portions at two sides of the board-end connector. Therefore, the cable-end connector can be properly inserted into the board-end connector and cannot be detached easily, so that the release-proof function for the connector assembly can be achieved.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A cable-end connector, comprising:
a mating shell having a receiving cavity, wherein two ends of the cable-end connector respectively have a mating opening and a cable-connecting opening which are in communication with the receiving cavity, and each of two sides of the mating shell has a buckling portion;
a circuit board in the receiving cavity, wherein one of two ends of the circuit board comprises a mating end portion exposed from the mating opening, and two faces of the mating end portion have a plurality of first contacts; and
a plurality of locking members, wherein each of the locking members comprises a main body and a flexible sheet, the main body of each of the locking members is at a corresponding one of the buckling portions, the flexible sheet extends outward from the main body, and two sides of the flexible sheet respectively comprise a press portion and a hook portion.

2. The cable-end connector according to claim 1, wherein each of the buckling portions comprises two side wall portions and an insertion block, the side wall portions protrude from the two sides of the mating shell, the insertion block extends outward from the side wall portions and adjacent to two sides of the mating opening, an outer wall of each of the side wall portions has an inclined surface, each of the buckling portions has a first buckling groove and a second buckling groove, the first buckling groove is between the side wall portions, the second buckling groove is at a side end of the insertion block, the press portion is exposed from the first buckling groove and is movably adjacent to the inclined surface, and the hook portion is movably exposed from the second buckling groove.

3. The cable-end connector according to claim 1, further comprising a covering member, wherein the mating shell has a recessed portion at the cable-connecting opening, and the covering member is at the recessed portion to cover the cable-connecting opening.

4. The cable-end connector according to claim 1, wherein the other end of the circuit board comprises a connecting end portion, and two faces of the connecting end portion have a plurality of second contacts.

5. The cable-end connector according to claim 4, further comprising an optoelectronic conversion module on the circuit board.

6. A board-end connector arranged on a circuit board and adapted to be mated with a cable-end connector, wherein the board-end connector comprises:
a mating housing having a receiving groove, wherein two ends of the board-end connector respectively have an insertion opening and an assembling opening which are in communication with the receiving groove, and each of two sides of the mating housing has an engaging portion, the engaging portions are adapted to be mated with buckling portions of the cable-end connector, and the insertion opening is adapted to be mated with a mating end portion of a circuit board of the cable-end connector;
a first terminal module comprising a first terminal base and a plurality of first flexible terminals at the first terminal base, wherein each of the first flexible terminals comprises a first contact portion, and each of the first contact portions is at one of two sides of the receiving groove and extends toward the insertion opening;
a second terminal module comprising a second terminal base and a plurality of second flexible terminals at the second terminal base, wherein each of the second flexible terminals comprises a second contact portion, and each of the second contact portions is at the other side of the receiving groove and extends toward the insertion opening; and
a covering housing covering the mating housing.

7. The board-end connector according to claim 6, wherein each of the engaging portions has a slide groove, the slide grooves are recessed inward from the two sides of the mating housing, the slide grooves are at two sides of the insertion opening, and each of the engaging portions has an engaging groove at an inner wall of a corresponding one of the slide grooves.

8. The board-end connector according to claim 6, further comprising a grounding sheet between the first terminal module and the second terminal module, wherein each of two sides of the grounding sheet comprises a pin exposed from the assembling opening.

9. The board-end connector according to claim 6, wherein the circuit board has a plurality of contacts and a plurality of fixing holes, each of the first flexible terminals comprises a first tail portion, each of the second flexible terminals comprises a second tail portion, each of the first tail portions and each of the second tail portions are exposed from the assembling opening and connected to corresponding ones of the contacts, each of two sides of the covering housing comprises a fixing leg, and each of the fixing legs is at a corresponding one of the fixing holes.

10. The board-end connector according to claim 9, further comprising an optoelectronic conversion module on the circuit board.

11. A connector assembly, comprising:
a cable-end connector, comprising:
a mating shell having a receiving cavity, wherein two ends of the cable-end connector respectively have a mating opening and a cable-connecting opening which are in communication with the receiving cavity, and each of two sides of the mating shell has a buckling portion;
a circuit board in the receiving cavity, wherein one of two ends of the circuit board comprises a mating end portion exposed from the mating opening, and two faces of the mating end portion have a plurality of first contacts; and
a plurality of locking members, wherein each of the locking members comprises a main body and a flexible sheet, the main body of each of the locking members is at a corresponding one of the buckling portions, the flexible sheet extends outward from the main body, and two sides of the flexible sheet respectively comprise a press portion and a hook portion; and
a board-end connector, comprising:
a mating housing having a receiving groove, wherein two ends of the board-end connector respectively have an insertion opening and an assembling opening which are in communication with the receiving groove, each of two sides of the mating housing has an engaging portion, the engaging portions are adapted to be mated with the buckling portions of the cable-end connector, and the insertion opening is adapted to be mated with the mating end portion of the circuit board of the cable-end connector;
a first terminal module comprising a first terminal base and a plurality of first flexible terminals at the first terminal base, wherein each of the first flexible terminals comprises a first contact portion, each of the first contact portions is at one of two sides of the receiving groove and extends toward the insertion opening, and each of the first contact portions is adapted to contact a corresponding one of the first contacts at one of the two faces of the mating end portion;
a second terminal module comprising a second terminal base and a plurality of second flexible terminals at the second terminal base, wherein each of the second flexible terminals comprises a second contact portion, each of the second contact portions is at the other side of the receiving groove and extends toward the insertion opening, and each of the second contact portions is adapted to contact a corresponding one of the first contacts at the other face of the mating end portion; and
a covering housing covering the mating housing.
